(19) United States
(12) Patent Application Publication
(10) Pub. No.: US 2010/0303185 A1
(43) Pub. Date: Dec. 2, 2010

(54) Methods of Operating Wireless Communications Devices Including Detecting Times of Receipt of Packets and Related Devices

(76) Inventor: Jacobus Cornelis Haartsen, Hardenberg (NL)

Correspondence Address: MYERS BIGEL SIBLEY & SAJOVEC, P.A., P.O. BOX 37428, RALEIGH, NC, 27627, US

(21) Appl. No.: 12/476,543

(22) Filed: Jun. 2, 2009

(51) Int. Cl. H04L 7/04; H04B 7/00

(52) U.S. Cl. 375/362; 455/70

(57) ABSTRACT

A method of operating a wireless communications device may include determining a wake-up time for a receiver using a low frequency clock. Beginning at the wake-up time, the receiver may listen for reception of a packet transmitted from a remote device over a wireless interface. An actual time of reception of the packet transmitted from the remote device may be detected, and a new wake-up time for the receiver may be determined using the low frequency clock and the actual time of reception of the packet.

### FIELD OF THE INVENTION

The present invention relates generally to the field of electronics, and more particularly, to communications methods providing receiver sleep windows and related devices.

### BACKGROUND

There is a wide variety of digital communication systems, some presently in existence, and some still under development. Digital communication systems such as Wireless Local Area Network (WLAN) and Bluetooth systems allow equipment to collaborate by means of wireless networks. Other types of digital communications systems include time-division multiple access (TDMA) systems, such as cellular radio telephone systems that comply with the Global System for Mobile communications (GSM) telecommunication standard and its enhancements like GSM/EDGE, and Code-Division Multiple Access (CDMA) systems, such as cellular radio telephone systems that comply with the IS-95, cdma2000, and Wideband CDMA (WCDMA) telecommunication standards. Digital communication systems also include “blended” TDMA and CDMA systems, such as cellular radio telephone systems that comply with the Universal Mobile Telecommunications System (UMTS) standard, which specifies a third generation (3G) mobile system being developed by the European Telecommunications Standards Institute (ETSI) within the International Telecommunication Union's (ITU's) IMT-2000 framework. The Third Generation Partnership Project (3GPP) promulgates the UMTS standard. High Speed Downlink Packet-data Access (HSDPA) is an evolution of WCDMA specified in the Release 5 version of the 3GPP WCDMA specification. The 3GPP has begun considering the next major step or evolution of the 3G standard (sometimes called Super 3G—“S3G”) to ensure the long-term competitiveness of 3G.

One thing that these different systems have in common is the need to maintain accurate timing. In modern radio transceivers (e.g., Bluetooth and WLAN equipment, and WCDMA, GSM and S3G phones), two different clocks are used: a system clock (SC) and a real-time clock (RTC). The SC is usually a high frequency clock, running at several MHz, and generated by a highly stable oscillator, often applying a temperature-controlled crystal. The SC acts as the reference and is the frequency source for all radio related operations, such as radio frequency (RF) carrier synthesis. The crystals used for the SC have an accuracy on the order of 20 parts per million (ppm). However, this accuracy may be improved by locking the SC to the downlink signals. The SC is tuned to the downlink signals and therefore inherits the better stability of the clock reference used in the base station, which is about 0.5 ppm.

The SC's stability is obtained at the expense of electrical current consumption. To run the SC, several milliAmperes (mA) may be required. In particular, the SC may require too much current when the transceiver is in idle mode or in a low-power mode in which it sleeps most of the time. Therefore, the SC is turned off during the sleep states. In order to preserve timing during such sleep states, each modern transceiver also includes a non-reference clock, such as a low-power oscillator (LPO) or real-time clock (RTC) which runs at a much lower level of current consumption (several tens to hundreds of micro Amperes). The RTC usually runs at a much lower frequency than the SC, typically several kHz.

The RTC is used for several timing operations. It controls the sleep periods (also referred to as sleep windows), and determines such things as when the terminal has to wake up to monitor the paging control channel or scan other broadcast control channels.

The inherent stability of the RTC may be relatively poor, typically from 50 to 100 ppm. However, its stability may be improved by repeated calibrations. The SC is used as a stable reference during the calibration. Once the RTC is calibrated, it may have a level of stability close to the stability of the SC. In between calibration events, the stability may remain within a few ppm.

U.S. Pat. No. 6,124,764 describes a calibration method that exploits the periodic paging wake-up times.

Conventional calibration techniques may require undesirably long calibration times. During the calibration, the SC may be required to run causing an increased level of current consumption. In order to reduce power consumption, the calibration duty cycle may be kept low resulting in long periods between consecutive calibration updates. During these periods, the RTC may drift.

### SUMMARY

According to some embodiments of the present invention, a method of operating a wireless communications device may include determining a wake-up time for a receiver using a low frequency clock. Beginning at the wake-up time, the receiver may listen for reception of a packet transmitted from a remote device over a wireless interface. An actual time of reception of the packet transmitted from the remote device may be detected, and a new wake-up time for the receiver may be determined using the low frequency clock and the actual time of reception of the packet.

According to other embodiments of the present invention, a wireless communications device may include a low frequency clock and a receiver configured to receive wireless communications from a remote device over a wireless interface. A processor may be coupled to the low frequency clock and to the receiver, and the processor may be configured to determine a wake-up time for the receiver using the low frequency clock. The processor may be further configured to use the receiver to listen for reception of a packet transmitted from a remote device over the wireless interface beginning at the wake-up time for the receiver, and to detect an actual time of reception of the packet transmitted from the remote device. In addition, the processor may be configured to determine a new wake-up time for the receiver using the low frequency clock and the actual time of reception of the packet.

According to some embodiments of the present invention, methods of operating a wireless communications device may include timing a first receiver sleep window for a receiver using a low frequency clock with a high frequency clock of the receiver being turned off during the first receiver sleep window. Moreover, a frequency of the high frequency clock may be significantly greater than a frequency of the low frequency clock. At an end of the first receiver sleep window determined using the low frequency clock, the receiver may be awakened to listen for an access code of a data packet during a receiver sniff window with the high frequency clock being turned on during the receiver sniff window. An actual time of reception of the access code for the data packet transmitted from a remote device over the wireless interface during the receiver sniff window may be detected, and a second receiver sleep window may be timed using the low frequency clock based on the actual time of reception of the access code for the data packet.

A predicted time of reception of the access code for a data packet transmitted from a remote device over a wireless interface may be determined. Moreover, timing the second receiver sleep window using the low frequency clock based on the actual time of reception of the access code for the data packet may include adjusting the low frequency clock based on a difference between the predicted and actual times of reception of the access code for the data packet. More particularly, adjusting the low frequency clock may include reducing a frequency of the low frequency clock when the actual time of reception is after the predicted time of reception, and increasing a frequency of the low frequency clock when the actual time of reception is before the predicted time of reception.

Timing the second receiver sleep window using the low frequency clock based on the actual time of reception of the access code for the data packet may include synchronizing the low frequency clock with a clock of the remote device based on the actual time of reception of the access code received from the remote device. Timing a second receiver sleep window using the low frequency clock based on the actual time of reception of the access code for the data packet may include timing the subsequent receiver sleep window based on a recalculation of the frequency of the low frequency clock using the actual time of reception of the access code for the data packet.

Timing the second receiver sleep window may include timing the second receiver sleep window for the receiver following the sniff window with the high frequency clock being turned off during the second receiver sleep window. At an end of the second receiver sleep window determined using the low frequency clock, the receiver may be awakened to listen for the access code of a second data packet during the second receiver sniff window with the high frequency clock being turned on during the second receiver sniff window. An actual time of reception of the access code for the second data packet transmitted from the remote device over the wireless interface during the receiver sniff window may be detected, and a third receiver sleep window may be timed using the low frequency clock based on the actual time of reception of the access code for the second data packet.

Detecting an actual time of reception of the access code may include generating samples of a signal received at the receiver during the receiver sniff window, and detecting a match between the access code and the samples of the signal received at the receiver. More particularly, the samples may be generated at a sampling rate that is at least as great as a data rate of the data packet. The access code may include a pseudo-random access code such as a Bluetooth pseudo-random access code.

After detecting the actual time of reception of the access code, a payload of the data packet transmitted from the remote device over the wireless interface may be received. The data packet may be a media data packet for one channel of a multichannel media system such as a stereo and/or surround sound system. A payload of the media data packet following the access code may be received, and a media data stream including data from the media data packet may be generated. The media data stream may be decoded using the using the low frequency clock based on the actual time of reception of the access code for the data packet. In addition, the decoded media stream may be converted into an analog audio signal, and the analog audio signal may be converted to sound using a speaker. Moreover, the media data stream may be one of a plurality of audio data streams for multi-speaker sound reproduction.

According to other embodiments of the present invention, a wireless communications device may include a low frequency clock and a high frequency clock with a frequency of the high frequency clock being significantly greater than a frequency of the low frequency clock. A receiver may be coupled to the high frequency clock with the receiver being configured to receive wireless communications from a remote device over a wireless interface using the high frequency clock. A processor may be coupled to the low and high frequency clocks and to the receiver. The processor may be configured to time a first sleep window using the low frequency clock with the high frequency clock being turned off during the first sleep window, and to wake the receiver to listen for an access code of a data packet during a receiver sniff window using the high frequency clock after the first sleep window. The processor may be further configured to detect an actual time of reception of the access code for the data packet transmitted from the remote device over the wireless interface during the receiver sniff window, and to time a second receiver sleep window using the low frequency clock based on the actual time of reception of the access code for the data packet.

The processor may be further configured to determine a predicted time of reception of the access code for a data packet transmitted from a remote device over a wireless interface. Moreover, the processor may be configured to time the second receiver sleep window using the low frequency clock based on the actual time of reception of the access code by adjusting the low frequency clock based on a difference between the predicted and actual times of reception of the access code for the data packet. For example, the processor may be configured to adjust the low frequency clock by reducing a frequency of the low frequency clock when the actual time of reception is after the predicted time of reception, and by increasing a frequency of the low frequency clock when the actual time of reception is before the predicted time of reception.

The processor may be configured to time the second receiver sleep window using the low frequency clock based on the actual time of reception of the access code for the data packet by synchronizing the low frequency clock with a clock of the remote device based on the actual time of reception of the access code received from the remote device. The processor may be configured to time the second receiver sleep window using the low frequency clock based on the actual time of reception of the access code for the data packet by timing the subsequent receiver sleep window based on a recalculation of the frequency of the low frequency clock using the actual time of reception of the access code for the data packet.

The processor may be configured to time the second receiver sleep window by timing the second receiver sleep window for the receiver following the sniff window with the high frequency clock being turned off during the second receiver sleep window. In addition, the processor may be configured to wake the receiver at an end of the second receiver sleep window determined using the low frequency clock to listen for the access code of a second data packet during the second receiver sniff window with the high frequency clock being turned on during the second receiver sniff window. Moreover, the processor may be configured to detect an actual time of reception of the access code for the second data packet transmitted from the remote device over the wireless interface during the second receiver sniff window, and to time a third receiver sleep window using the low frequency clock based on the actual time of reception of the access code for the second data packet.

The processor may be configured to detect an actual time of reception of the access code by shifting samples of a signal received at the receiver during the receiver sniff window through a shift register, and detecting a match between the access code and the samples of the signal shifted through the shift register. More particularly, the signal received at the receiver may be sampled at a rate at least as great as a data rate of the data packet. The access code may include a pseudo-random access code such as a Bluetooth pseudo-random access code. The processor and the receiver may be further configured to receive a payload of the data packet transmitted from the remote device over the wireless interface after detecting the actual time of reception of the access code.

The data packet may be a media data packet, and the processor may be further configured to receive a payload of the media data packet following the access code, to generate a media data stream including data from the media data packet, and to decode the media data stream using the adjusted low frequency clock. In addition, an digital-to-analog converter may be configured to convert the decoded media data stream into an analog audio signal, and a loudspeaker may be configured to convert the analog audio signal to sound. For example the media data stream may be one of a plurality of audio data streams for multi-speaker sound reproduction.

### BRIEF DESCRIPTION OF THE DRAWINGS

FIG. 1 is a block diagram illustrating a wireless communications device according to some embodiments of the present invention.

FIGS. 2A, 2B, 2C, and 2D are timing diagrams illustrating sniff and sleep windows according to embodiments of the present invention.

FIG. 3 is a diagram illustrating a structure of a data packet including an access code according to some embodiments of the present invention.

FIGS. 4A and 4B are block diagrams of correlators according to some embodiments of the present invention.

FIG. 5 is a flow chart illustrating receiver operations according to some embodiments of the present invention.

### DETAILED DESCRIPTION

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawing, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that although the terms first and second are used herein to describe various elements, these elements should not be limited by these terms. These terms are only used to distinguish one element from another element. As used herein, the term “and/or” includes any and all combinations of one or more of the associated listed items. The symbol “/” is also used as a shorthand notation for “and/or”.

Various embodiments of the present invention are described below with reference to block diagrams illustrating methods, apparatus and computer program products according to various embodiments of the invention. It will be understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. Accordingly, it will be appreciated that the block diagrams and operational illustrations support apparatus, methods and computer program products.

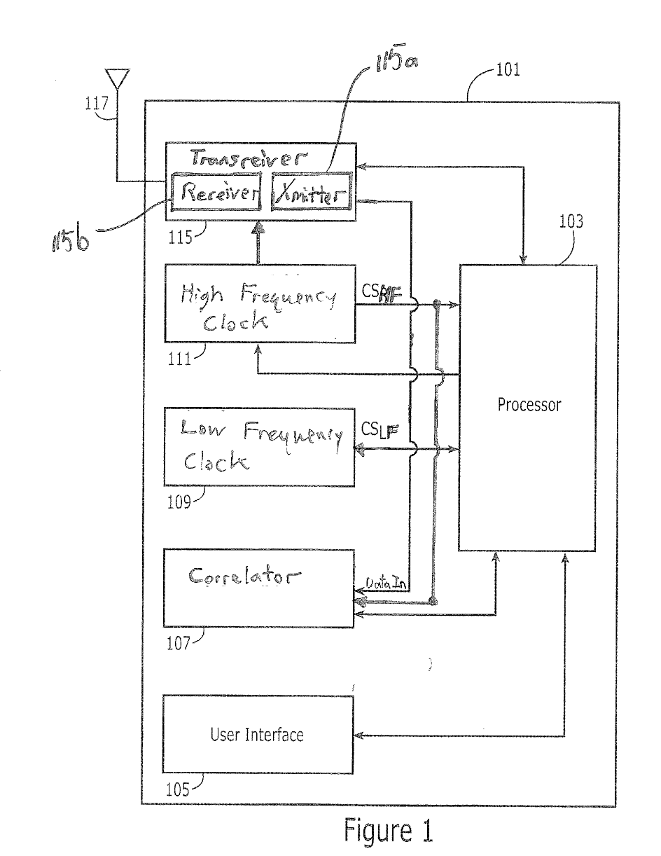

FIG. 1 is a block diagram illustrating a communications device 101 (e.g., a headset, a remote user interface, a remote keyboard, a remote display, a sensor, a mobile radiotelephone, a personal digital assistant or PDA, a handheld computer, a laptop computer, a notebook computer, etc.) according to some embodiments of the present invention. The communications device 101 (also referred to as a mobile device) may include a processor 103, a user interface 105, a correlator 107, a low frequency clock 109 (also referred to as a low power oscillator or LPO, low power clock, and/or a real-time clock or RTC), a high frequency clock 111 (also referred to as a system clock or SC, a reference clock, and/or a high power clock), a transceiver 115, and an antenna 117. The transceiver 115 may include both a transmitter 115a and a receiver 115b to provide both transmission and reception of radio communications, the transceiver 115 may include only a transmitter to provide only transmission of radio communications, or the transceiver 115 may include only a receiver to provide only reception of radio communications. Moreover, the transmitter 115 may provide low power wireless communications according to a standard such as a Bluetooth standard. The user interface 105 may include an image display (such as an LCD screen), a keypad, a joystick, a dial, directional buttons, a touch sensitive image display, a speaker, a microphone, etc.

According to some embodiments of the present invention, transmitter 115 may provide only low power wireless communications (e.g., Bluetooth communications). By way of example, the communications device 101 may be a wireless ear bud, a wireless speaker for a stereo and/or surround sound system, a wireless keyboard, a wireless screen, etc. According to other embodiments of the present invention, transmitter 115 may provide both low power wireless communications (e.g., Bluetooth communications) and higher power wireless communications (e.g., radiotelephone communications). For example, communications device 101 may be a cellular/satellite/wireless radiotelephone with a wireless Bluetooth interface.

The high frequency clock 111 (also referred to as a system clock, a reference clock, and/or a high power clock) may include a highly stable oscillator configured to generate a relatively high frequency clock signal CS_{HF} used as a frequency source for all radio related operations (such as radio frequency carrier synthesis) performed by the transceiver 115 during transmission and/or reception of radio signals. The high frequency clock signal CS_{HF} may have a frequency on the order of MHz, such as 13 MHz or 26 MHz. A 26 MHz clock, for example, may be used to derive a 4 MHz clock signal Moreover, the high frequency clock signal CS_{HF} may provide relatively high accuracy, for example, on the order of 20 ppm (parts per million) or even 0.5 ppm. High frequency clock 111 may thus provide a highly stable clock signal with high spectral purity used to support radio transceiver operations. Moreover, relatively high power may be consumed by high frequency clock to produce these characteristics.

The low frequency clock 109 (also referred to as a low-power oscillator, low-power clock, or real-time clock) may be configured to generate a relatively low frequency clock signal CS_{LF} used preserve timing during sleep mode operations of the communications device 101. Low frequency clock signal CS_{LF} may have a frequency on the order of kHz (e.g., 32.768 kHz or 44.1 kHz). Moreover, the low frequency clock signal CS_{LF} may provide relatively low accuracy/stability. According to embodiments of the present invention, high frequency clock signal CS_{HF} may have a frequency that is significantly greater than a frequency of low frequency clock signal CS_{LF}. A frequency of high frequency clock signal CS_{HF} may be at least about 10 times greater than a frequency of low frequency clock signal CS_{LF}. For example, high frequency clock signal CS_{HF} may have a frequency greater than about 500 kHz, and low frequency clock signal CS_{LF} may have a frequency less than about 50 kHz. More particularly, a frequency of high frequency clock signal CS_{HF} may be at least about 100 times greater than a frequency of low frequency clock signal CS_{LF}. For example, low frequency clock signal CS_{LF} may have a frequency of about 44.1 kHz and high frequency clock signal CS_{HF} may have a frequency of about 26 MHz, or low frequency clock signal CS_{LF} may have a frequency of about 32.768 kHz and high frequency clock signal CS_{HF} may have a frequency of about 26 MHz.

The processor 103 may process communications received from and/or communications to be transmitted through transceiver 115 responsive to user input received through user interface 105. The processor 103, for example, may process voice communications, network communications (such as Internet communications), text communications, data communications, media communications (e.g., audio and/or video communications), etc. During periods of active communications (e.g., when radio communications are being transmitted/received through transceiver 115), the high frequency clock 111 may generate the relatively high frequency clock signal CS_{HF} that is used by the transceiver 115.

When communications device 101 is not actively communicating using transceiver 115, communications device 101 may operate in a low power sleep state with the high frequency clock 111 turned off to conserve battery power. During the sleep state, low frequency clock signal CS_{LF} (generated by low frequency clock 109) is used to preserve timing of processor 103. During a low power sleep state, low frequency clock signal CS_{LF} may be used to determine when processor 103, transceiver 115, and high frequency clock 111 should wake to listen for a access code of a data packet, to monitor a paging control signal, and/or to scan broadcast control channels. For example, low frequency clock signal CS_{LF} may be used to determine when processor 103, receiver 115, and high frequency clock 111 should wake during a sniff window (e.g., a Bluetooth sniff window) to listen for an access code of a data packet transmitted from a remote device and intended for communications device 101.

Because an accuracy of low frequency clock signal CS_{LF} may be relatively low, processor 103 and/or correlator 107 may adjust a period and/or frequency of low frequency clock signal CS_{LF} based on a difference between predicted and actual times of reception of an access code during a sniff window. While the correlator 107 and processor 103 are illustrated as separate blocks for the sake of clarity, it will be understood that some or all functions/elements of correlator 107 may be included in processor 103 and/or other blocks of FIG. 1. By providing a more accurate period and/or frequency of low frequency clock signal CS_{LF}, sleep windows between wake periods/windows may be more accurately determined to further conserve battery power.

According to some embodiments of the present invention, a data packet 301 may include an access code 303 and a payload 305 as shown in FIG. 3. Data packet 301 may also include other fields such as a header field 307. According to some embodiments of the present invention, access code 303 may include 68 bits with a pseudo-random code, and payload 305 may include 0 to 2745 bits. If a header is included, header 307 may include 54 bits.

A Bluetooth access code 303, for example, may include a 4 bit preamble (“0101” or “1010”) followed by a 64 bit sync word derived from an address for communications device 101 with an overlay of a 64 bit full length PN (pseudo-random number) sequence. Accordingly, access code 303 may be used by receiver 115b, correlator 107, and/or processor 103 to identify a data packet intended for communications device 101. A Bluetooth access code may also include a 4 bit trailer following the sync word, and a Bluetooth data packet may be transmitted at a data rate of 1 bit per μs (microsecond) or 1 Mbit per second.

While the data packet 301 is shown with access code 303, header 307, and payload 305, all three of these segments are not required in every packet. Payload 305 may be omitted (i.e., no data is transmitted), for example, in control packets that are used to maintain synchronization between device 101 (acting as a slave receiver) and a remote device (acting as a master transmitter). According to some embodiments of the present invention, data packet 301 may include access code 303 and header 307 without payload 305, or data packet 301 may include access code 303 without header 307 and without payload 305.

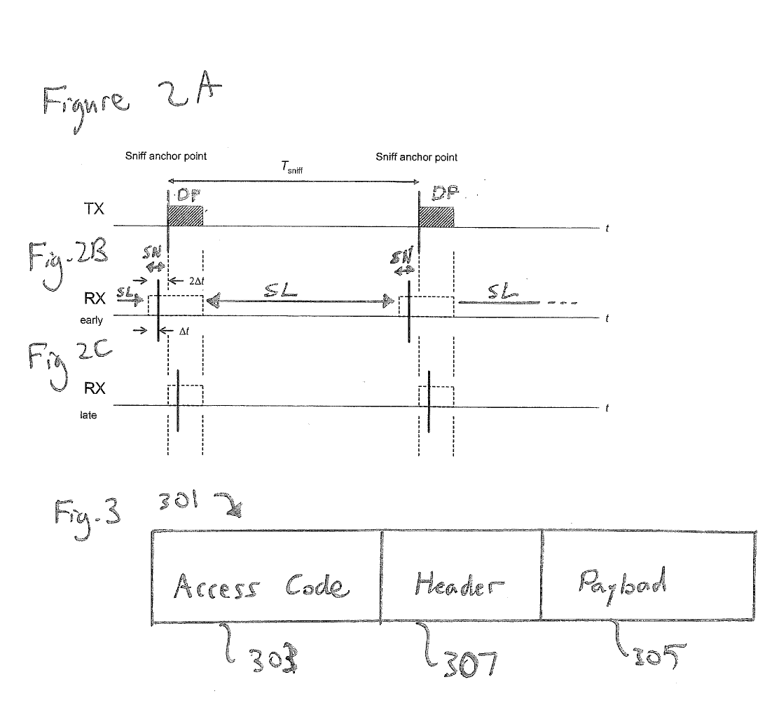

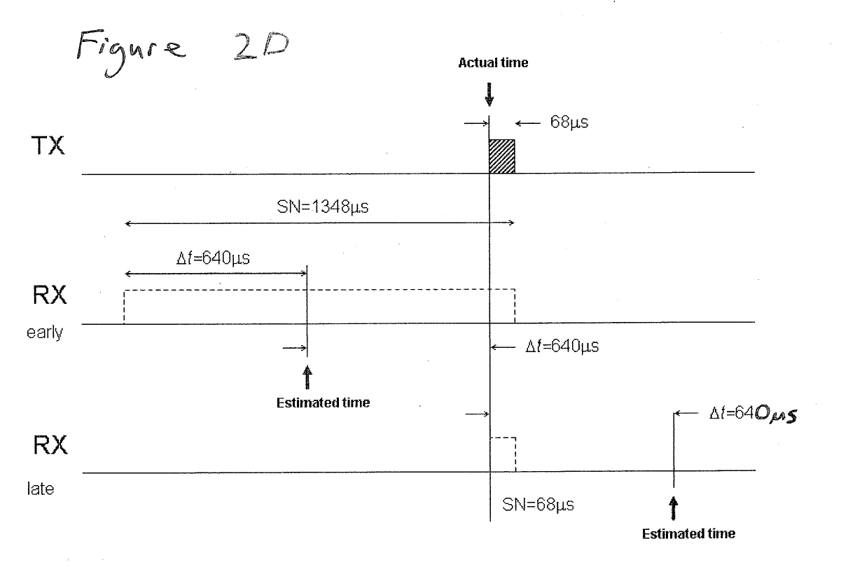

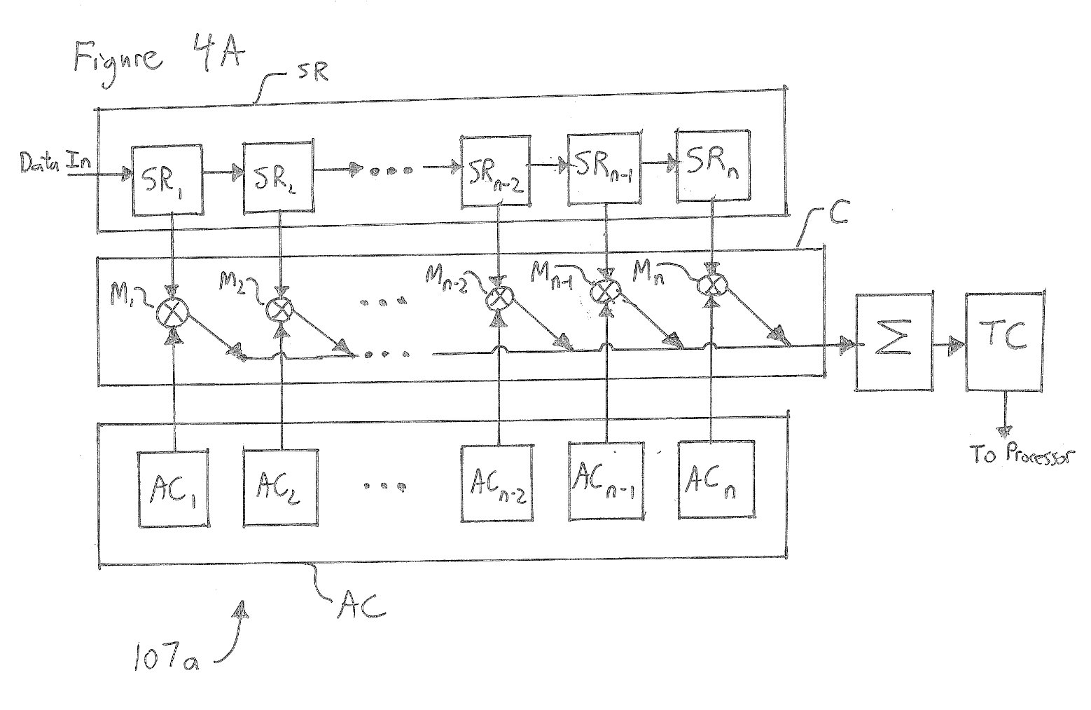

FIGS. 2A, 2B, and 2C are timing diagrams illustrating sniff windows SN and sleep windows SL according to embodiments of the present invention, and FIG. 2D is a greatly enlarged view of portions of FIGS. 2A, 2B, and 2C illustrating a period of time immediately preceding and following transmission of an access code. As discussed above, transceiver 115 and high frequency clock 111 may be turned off during sleep windows SL to reduce power consumption and thereby increase battery life. Accordingly, low frequency clock CS_{LF} is used by processor 103 to time sleep windows SL between sniff windows SN and data packet transmissions DP so that processor 103 can determine when to turn receiver 115b and high frequency clock 111 on for each sniff window SN. Stated in other words, low frequency clock signal CS_{LF} may be used to determine when to initiate sniff windows SN when receiver 115b and high frequency clock 111 are turned on. During a sniff window SN, receiver 115b, correlator 107, and/or processor 103 listen for an access code to determine if a data packet has been transmitted to the communications device 101.

As shown in FIG. 2A, data packets DP may be transmitted at regular intervals, and sniff anchor points may be defined as times of transmission/reception of access codes of the data packets DP. Because timings of transmission of access codes of data packets are precisely timed by the transmitting device, a time of reception of the access codes can be used to accurately adjust low frequency clock 109 of receiving communications device 101. In other words, a length of time or interval T_{sniff} can be determined at receiving device 101 by detecting times that access codes of consecutive data packets DP are received, and length of time or interval T_{sniff} may be used to adjust a period and/or frequency of low frequency clock signal CS_{LF}, to calculate an offset for low frequency clock signal CS_{LF}, and/or to more accurately determine a frequency of low frequency clock signal CS_{LF}.

By providing improved accuracy of low frequency clock 109, lengths of sniff windows SN may be reduced to further reduce power consumption. If lengths of sniff windows SN are reduced too far, however, a probability of missing a data packet intended for the communications device may be increased. In particular, processor 103 and receiver 115b need to be able to accurately determine when a remote sender will transmit, but inaccuracy in low frequency clock 109 may require a minimum duration of a sniff window SN to ensure that the receiver 115b is on when an access code for communications device 101 is transmitted.

As shown in FIG. 2A, a remote device may transmit data packets DP beginning at regularly spaced sniff anchor points separated by time period (also referred to as a sniff interval) T_{sniff}. As shown in FIG. 2B, processor 103 may use low frequency clock 109 to determine start times of sniff windows SN. Because communications device 101 is listening for data to be received from a remote transmitter, communications device 101 may be referred to herein as a slave device. As noted above, low frequency clock signal CS_{LF} is used by processor 103 to initiate sniff windows SN. Because of drift of low frequency clock 109, processor 103 may have to initiate a sniff window SN before an expected transmit timing and to maintain a sniff window SN after an expected transmit timing so as not to miss a data packet. If a data packet is transmitted before initiation of sniff window SN, the data packet may be missed. A shown in FIG. 2B, a longer delay between initiation of a sniff window SN and receipt of a data packet may result in unnecessary power consumption because the high frequency clock 111 and receiver 115 may be turned on longer than necessary.

An uncertainty window Δt (delta t) may depend on a mutual drift of low frequency clock signal CS_{LF} and high frequency clock signal CS_{HF}. According to the Bluetooth specification, a maximum mutual drift may be as great as ±500 ppm (parts per million) so that uncertainty window Δt (delta t) may be 640 μs (microseconds). Lengths of sniff windows SN may thus vary depending on inaccuracies of low frequency clock CS_{LF} and resulting inaccuracies of an estimated time of receipt of data packet access code. As shown in the RX early timeline of FIG. 2D (corresponding to FIG. 2B), if an estimated time of reception is 640 μs early (i.e., a full extent of uncertainty window Δt) and the sniff window is initiated 640 μs (microseconds) before the estimated time of reception, receiver 115b and high frequency clock 111 may be on for a sniff window of 1348 μs before receiving the access code. More particularly, the sniff window may have a duration of 640 μs (before the estimated time of reception of the access code) plus 640 μs (between the estimated time of reception and an initiation of transmission of the access code) plus 68 μs (between the initiation and completion of transmission of the access code). In this RX early scenario, receiver 115b may scan unnecessarily for 1280 μs using high frequency clock 111. As shown in the RX late timeline of FIG. 2D (corresponding to FIG. 2C), if an estimated time of reception is 640 μs late (i.e., a full extent of uncertainty window Δt), receiver 115b and high frequency clock 111 may turn on just as a first bit of the access code is being transmitted, which may be insufficient to actually receive the access code, resulting in a lost data packet and/or link.

With a sniff window SN of 2*Δt (e.g., 1,280 μs) plus the length of the access code as shown by the RX early timeline of FIG. 2D, high frequency clock 111 and receiver 115b may be unnecessarily turned on for more than 1 ms (millisecond). If a following payload is transmitted in a single frame of 1.25 ms, high frequency clock 111 and receiver 115b may be turned on for a period of time waiting for the data packet that is nearly as long as a period required to actually receive the data packet. If high frequency clock 111 and receiver 115b are turned on too late as shown by the RX late timeline of FIG. 2D, the access code (and the rest of the data packet) may be missed, and the communications link may be lost. By increasing an accuracy of low frequency clock CS_{LF} according to embodiments of the present invention, uncertainty window Δt may be reduced thereby reducing average lengths of sniff windows and/or reducing a probability of missing a data packet.

Processor 103 may use low frequency clock signal CS_{LF} (generated by low frequency clock 109) to time a receiver sleep window for receiver 115b, and high frequency clock 111 (used to generate high frequency clock signal CS_{HF}) and receiver 115b may be turned off during the receiver sleep window to reduce power/current consumption. A frequency of high frequency clock signal CS_{HF} may be significantly greater (e.g., at least about 100 times greater) than a frequency of low frequency clock signal CS_{LF}, and high frequency clock 111 may consume substantially more power than low frequency clock 109. Processor 103 may also use low frequency clock signal CS_{LF} to determine a predicted time of reception of an access code for a data packet transmitted from a remote device over a wireless interface. At an end of the receiver sleep window determined using low frequency clock 109, receiver 115b may be awakened to listen for the access code of a data packet during a receiver sniff window, and high frequency clock 111 may be turned on during the receiver sniff window to provide high frequency clock signal CS_{HF} for receiver 115b. During the receiver sniff window, receiver 115b may generate symbols/bits at a rate at least as great as a data rate of data packets being received. Sliding correlator 107 may be used to listen for the access code by matching an incoming signal (Data In) from receiver 115b with a known access code.

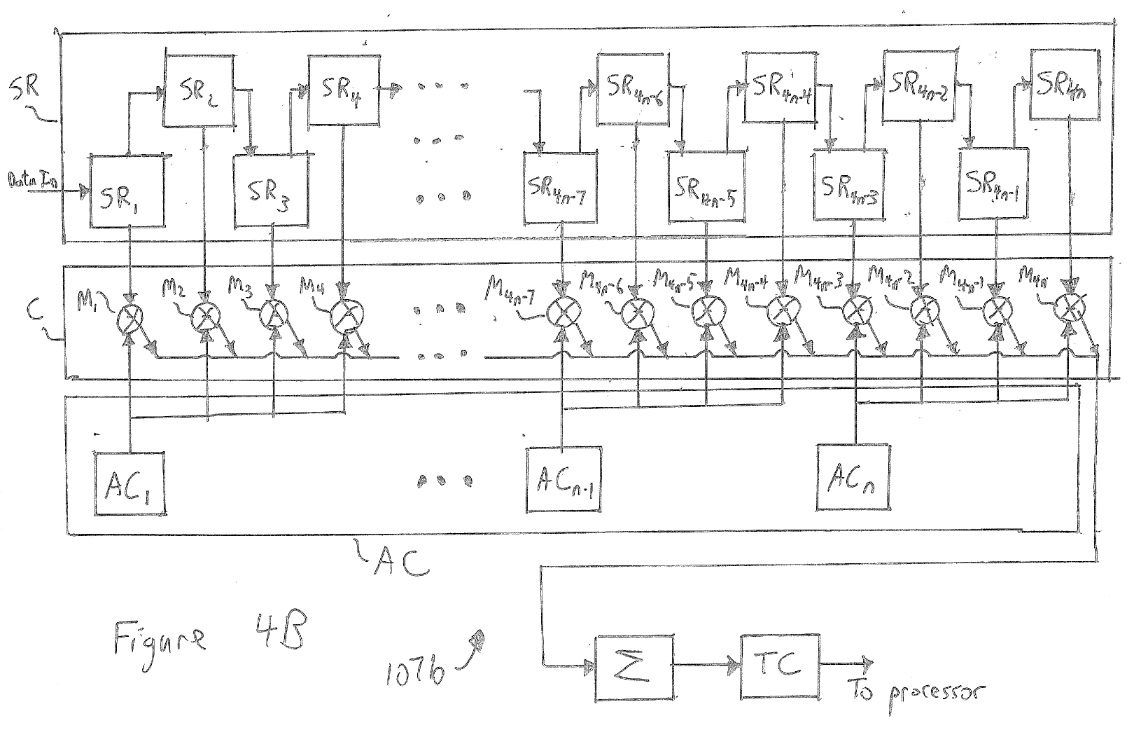

As shown in FIG. 4A, correlator 107 may be a sliding correlator 107a including a shift register SR with individual registers SR₁ to SRₙ, a comparator C with multipliers M₁ to Mₙ, an access code register AC with registers AC₁ to ACₙ, summer Σ, and threshold comparator TC. With the correlator 107a of FIG. 4A, n is equal to a number of bits in the access code, and receiver 115b may provide Data In at a data rate of the data packet to be received. Each access code register AC₁ to ACₙ may store a respective bit/symbol (e.g., +1 or −1) of the known access code, and bits/symbols (e.g., +1 or −1) may be clocked through shift registers SR₁ to SRₙ at a data rate of the data packet transmitted from the remote device. In a Bluetooth receiver, for example, n may be 68, and the data rate may be 1 bit per μs (microsecond) or 1 Mbit per second.

With each shift of data through the shift registers SR₁ to SRₙ, a bit in each shift register SR₁ to SRₙ is compared with a bit in a respective access code register AC₁ to ACₙ using comparator C, and results of the n comparisons may be summed using summer Σ. The sum generated by summer Σ may thus increase with each match between respective shift and access code registers, and the sum generated by summer Σ may decrease with each mismatch between respective shift and access code registers. If the resulting sum is greater than a threshold as determined by threshold comparator TC, threshold comparator TC may generate a signal to indicate that the access code has been received to initiate reception of the following payload of the data packet. If the resulting sum is less than the threshold determined by threshold comparator TC, operations of correlator 107a may continue until the access code is received.

More particularly, comparator C may compare bits in shift registers SR₁ to SRₙ with bits in a respective access code register AC₁ to ACₙ using multipliers M₁ to Mₙ to multiply outputs of respective shift and access code registers. Where outputs of corresponding shift and access code registers SRₓ and ACₓ are the same (i.e., +1 and +1, or −1 and −1), the product produced by corresponding multiplier Mₓ will be +1 thereby increasing a sum generated by summer Σ. Where outputs of corresponding shift and access code registers SRₓ and ACₓ are different (i.e., +1 and −1, or −1 and +1), the product produced by corresponding multiplier Mₓ will be −1 thereby reducing a sum generated by summer Σ. With a 68 bit access code, summer Σ will generate a sum of 68 with a perfect match. Threshold comparator TC may use a threshold of something less than 68 to signal receipt of the access code, however, to allow for some error in reception. A threshold of 60, for example, may be used to signal receipt of the access code while allowing an error in four of the 68 bits of the access code.

By sampling bits/symbols at a data rate of the data packet as shown in FIG. 4A, a receipt of the access code may be timed to within ± a duration of a bit of a data packet. By sampling at a rate of 1 sample per μs (microsecond) and by shifting and comparing bits each microsecond using sliding correlator 107a of FIG. 4a, a receipt of an access code may be timed to within ±1 microsecond.

An accuracy of the timing of receipt of the access code may be further improved by increasing a rate of sampling at receiver 115b and shifting the resulting bits/symbols through a larger shift register SR at the higher sampling rate. As shown in FIG. 4B, for example, bits/symbols may be sampled by receiver 115b at a sampling rate that is 4 times greater than a data rate of the data packet. Accordingly, shift register SR may include shift registers SR₁ to SR₄ₙ (i.e., 4 registers for each bit of the access code), comparator C may include multipliers M₁ to M₄n (i.e., 4 multipliers for each bit of the access code), and Access code register AC may include access code registers AC₁ to ACₙ (i.e., 1 access code register for each bit of the access code). Accordingly, each access code register ACₓ may be coupled to four consecutive multipliers Mₓ to Mₓ₊₃. Accordingly, bits/symbols from receiver 115b are shifted through shift registers SR₁ to SR₄ₙ at 4 times a data rate of the data packet, summer Σ combines outputs of multipliers M₁ to M₄ₙ, and threshold comparator TC determines when the access code has been received based on an output of summer Σ exceeding a threshold. With a 68 bit access code and 4 times oversampling, summer Σ will generate a sum of 272 (i.e., 68×4) with a perfect match. Threshold comparator TC may use a threshold of something less than 272 to signal receipt of the access code, however, to allow for some error in reception. Otherwise, operations/elements of sliding correlator 107b are the same as those discussed above with respect to sliding correlator 107a of FIG. 4B.

With 4 times over sampling as discussed above with respect to FIG. 4B, a receipt of the access code may be timed to within ±250 nanoseconds (i.e., 0.25 microseconds). While sliding correlator 107b of FIG. 4B with 4 times over sampling is discussed above by way of example, other over sampling rates may be provided. For example, 2 times over sampling may be provided with a sliding correlator having 2n shift registers and 2n multipliers to time receipt of an access code to within ±500 nanoseconds, or 3 times over sampling may be provided with a sliding correlator having 3n shift registers and 3n multipliers to time receipt of an access code to within ±333 nanoseconds.

Processor 103 may thus use the signal generated by threshold comparator TC to detect an actual time of reception of the access code for the data packet transmitted from the remote device over the wireless interface during the receiver sniff window. Processor 103 may then more accurately time a second receiver sleep window using the low frequency clock signal based on the actual time of reception of the access code for the data packet.

According to some embodiments of the present invention, processor 103 may determine a predicted time of reception of an access code for a data packet transmitted from a remote device over a wireless interface. In addition, processor 103 may be configured to time the second receiver sleep window using the low frequency clock based on the actual time of reception of the access code for the data packet by adjusting the low frequency clock based on a difference between the predicted and actual times of reception of the access code for the data packet. More particularly, adjusting the low frequency clock may include reducing a frequency of low frequency clock 109 when the actual time of reception is after the predicted time of reception, and/or increasing a frequency of low frequency clock 109 when the actual time of reception is before the predicted time of reception. A frequency of low frequency clock 109 may be adjusted, for example, by adjusting a bias current of a low power oscillator of low frequency clock 109, and/or by adjusting a varactor in parallel with an oscillator of low frequency clock 109.

According to other embodiments of the present invention, processor 103 may be configured to time the second receiver sleep window using low frequency clock 109 based on a recalculation of the frequency of the low frequency clock using the actual time of reception of the access code for the data packet. Processor 103, for example, may be configured to count a number of cycles of low frequency clock signal CS_{LF} between times of receipt of different access codes. Because actual times of receipt of access codes can be accurately measured as discussed above and because a transmitting device accurately times transmission of the access codes at a fixed frequency, a number of cycles of low frequency clock signal CS_{LF} occurring between receipt of two access codes can be used to accurately determine a frequency of low frequency clock signal CS_{LF}. Accordingly, processor 103 may use the accurately determined frequency of low frequency clock signal CS_{LF} to time subsequent sleep windows instead of adjusting a frequency of low frequency clock signal CS_{LF}.

According to still other embodiments of the present invention, low frequency clock 109 may remain free running, and processor 103 may calculate and add an offset to low frequency clock signals CS_{LF}. The offset may be updated periodically using the calibration process. For example, an averaging process may be used taking into account several packet receptions. More particularly, a number of cycles of low frequency clock signals CS_{LF} may be counted beginning at receipt of an access code for an initial data packet, and an accumulated count of cycles may be taken at receipt of the access code for each subsequent data packet. A difference between an expected accumulated count of cycles at receipt of the access code for each data packet may be compared with the actual accumulated count of cycles at receipt of the access code for each data packet, and the differences between expected and actual counts at receipt of the access code for each data packet may be used to calculate an offset.

If low frequency clock signal CS_{LF} is running fast, the offset may be positive (i.e., the actual count will exceed the expected count), and a magnitude of the positive offset may increase with receipt of the access code for each successive data packet. If low frequency clock signal CS_{LF} is running slow, the offset may be negative (i.e., the expected count will exceed the actual count), and a magnitude of the negative offset may increase with receipt of the access code for each successive data packet. By calculating offsets based on counts received over a plurality of packet receptions, an averaging effect may be provided. Offsets so calculated may thus be added/subtracted to/from low frequency clock signal CS_{LF} to more accurately time sleep windows according to embodiments of the present invention. Offsets used to correct low frequency clock signal CS_{LF} may be recalculated at each receipt of an access code, and/or offsets may be updated between access codes using an extrapolation technique such as linear regression to provide more accurate corrections.

As discussed above, processor 103 can use detection of an access code of a data packet to improve a timing of a subsequent sleep window. In addition, detection of the access code can be used to trigger processor 103 to begin processing a payload of the data packet being received through receiver 115b. According to some embodiments of the present invention, the data packet may be a media data packet (such as a multichannel media packet for stereo and/or surround sound). Accordingly, a media stream may be generated including data from the payload of the media data packet and payloads from other media data packets received at receiver 115b. Moreover, the resulting media data stream may be decoded using the low frequency clock 109 (based on the actual time of reception of the access code for the data packet) as a reference. As discussed above, an accuracy of a frequency of low frequency clock 109 may be adjusted/improved by detecting the actual time of receipt of the access code so that a channel of the media data stream generated at communications device 101 may be more accurately synchronized with other channels of the media stream received at other devices. Moreover, the time of receipt of the access code may be used to synchronize low frequency clock signal CS_{LF} with a clock of the master device transmitting the access code. Low frequency clock 109, for example, may generate low frequency clock signal CS_{LF} having a frequency of 32 kHz that is used as a reference for pulse code modulation (PCM). A phase lock loop (PLL) may be used to multiply the 32 kHz frequency to a higher frequency (e.g., 96 kHz or higher), so that PCM decoding may be performed at the higher frequency and so that high frequency clock 111 may be turned off.

Communications device 101 of FIG. 1, for example, may be one wireless speaker/earbud of a wireless stereo system where no connection/communication is provided with the other speaker/earbud. Processor 103, for example, may include an audio decoder used to decode the data stream using low frequency clock 109 to provide a reference for pulse code modulation (PCM). Processor 103 may also include a digital-to-analog converter to convert the decoded media stream into an analog audio signal, and the analog audio signal may be provided to a speaker/loudspeaker of user interface 105 to convert the analog audio signal to sound. By using a detected time of receipt of the access code to improve an accuracy of low frequency clock 109, low frequency clock 109 may be used for both timing of sleep mode receiver operations and timing of pulse code modulation decoding. Accordingly, high frequency clock 111 is not required for audio decoding so that high frequency clock 111 can be turned off when not needed for transceiver operations. When receiving an audio data stream, receiver 115b may receive data packets in bursts with receiver 115b and high frequency clock 111 turned off between bursts to reduce power consumption. Payloads from the data packets, however, may be continuously decoded using low power clock 109, and an improved accuracy of low power clock 109 may provide sufficient synchronization with a related media data stream(s) decoded at another communications device (e.g., at another wireless speaker/earbud of a stereo and/or surround sound system). More particularly, by detecting times of receipt of access codes, low power clock 109 may be synchronized with a clock of the remote device transmitting the access codes to communications device 101.

According to some embodiments of the present invention, a compressed (e.g., ATRAC-3 or ATRAC-x) audio stream may be wirelessly transmitted from a master device to receiver 115b of communications device 101 in bursts, and then decoded using low frequency clock 109 (e.g., at 44.1 kHz) synchronized with the transmitting master device. Low frequency clock 109 may thus be used to time receiver sleep windows and to time audio decoding, while high frequency clock 111 (e.g., at 26 MHz) is only turned on when operating transceiver 115. Transmission, reception, and synchronization of left and right audio data streams is discussed, for example, in U.S. patent application Ser. No. 12/169,848 entitled “Apparatus And Methods For Time Synchronization Of Wireless Audio Data Streams” and filed Jul. 9, 2008, the disclosure of which is hereby incorporated herein in its entirety by reference.

As discussed above, processor 103 may be defined to include an audio decoder and digital-to-analog converter, but one or both of the audio decoder and/or digital-to-analog converter may be defined as a separate element(s) outside processor 103. Moreover, user interface 105 may be defined ton include the audio decoder and/or digital-to-analog converter.

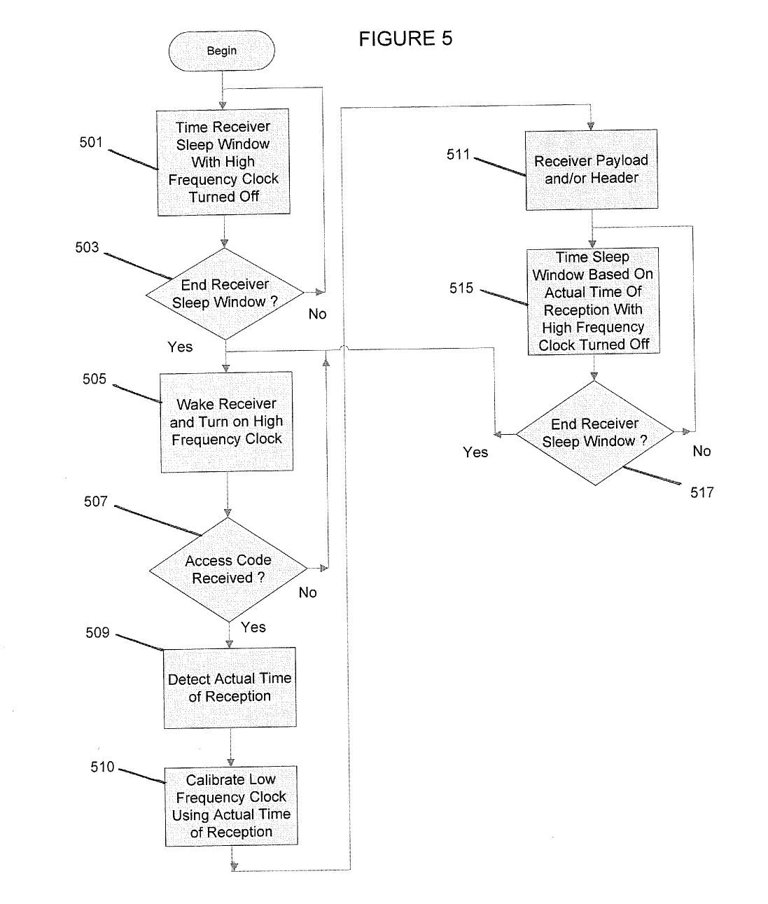

FIG. 5 is a flow chart illustrating receiver operations according to some embodiments of the present invention. At blocks 501 and 503, processor 103 may use low frequency clock signal CS_{LF} to time a receiver sleep window with high frequency clock 111 being turned off during the receiver sleep window. At an end of the receiver sleep window determined using low frequency clock signal CS_{LF} at block 503, processor 103 may wake receiver 115b at block 505 to listen for an access code of a data packet during a receiver sniff window using high frequency clock signal CS_{HF} (i.e., with high frequency clock signal turned on) during a receiver sniff window.

Once an access code is received at block 507, processor 103 and/or correlator 107 may detect an actual time of reception of the access code for the data packet at block 509 as discussed above, for example, with respect to FIGS. 4A and 4B. At block 510, low frequency clock 109 may be calibrated based on the actual time of reception of the access code, for example, by adjusting a frequency of low frequency clock 109, by recalculating a frequency of low frequency clock 109, and/or by calculating an offset that may be added to and/or subtracted from low frequency clock signal CS_{LF}, as discussed above. A header and/or payload of the data packet may optionally be received at block 511 if the data packet is being used to transmit data. If the data packet is only used to maintain synchronization, however, block 511 may be omitted. At blocks 515 and 517, a next receiver sleep window may be timed using low frequency clock 109 based on the actual time of reception of the access code for the data packet.

Before receiving the access code, for example, processor 103 may determine a predicted time of reception of the access code for a data packet transmitted from the remote device over the wireless interface. Processor 103 may then time the next receiver sleep window by adjusting a period/frequency of low frequency clock 109 based on a difference between the predicted and actual times of reception of the access code for the data packet. More particular, a frequency of low frequency clock 109 may be reduced when the actual time of reception is after the predicted time of reception, and a frequency of low frequency clock 109 may be increased when the actual time of reception is before the predicted time of reception. In addition or in an alternative, timing the second receiver sleep window may include synchronizing low frequency clock 109 with a clock of the remote transmitting device (i.e., the master) based on the actual time of reception of the access code received from the remote device.

Operations of blocks 505 to 517 of FIG. 5 may then be repeated for any number of data packets received at communications device 101. With each access code received, a frequency of low frequency clock signal CS_{LF} may be readjusted and/or resynchronized to maintain an accuracy of timing for receiver sleep windows and/or audio decoding. Accordingly, a synchronization of low frequency clock 109 with respect to a clock of a master transmitting device may be maintained. Accordingly, low frequency clock CS_{LF} may be adjusted over multiple cycles to correct for trends.

In the drawings and specification, there have been disclosed embodiments of the invention and, although specific terms are employed, they are used in a generic and descriptive sense only and not for purposes of limitation, the scope of the invention being set forth in the following claims.

That which is claimed is:

1. A method of operating a wireless communications device, the method comprising:
determining a wake-up time for a receiver using a low frequency clock;
beginning at the wake-up time, listening at the receiver for reception of a packet transmitted from a remote device over a wireless interface;
detecting an actual time of reception of the packet transmitted from the remote device; and
determining a new wake-up time for the receiver using the low frequency clock and the actual time of reception of the packet.

2. A method according to claim 1 further comprising:
determining a predicted time of reception of the packet transmitted from the remote device,
wherein determining the new wake-up time for the receiver comprises adjusting the low frequency clock based on a difference between the predicted and actual times of reception of the packet and wherein the new wake-up time for the receiver is determined using the adjusted low frequency clock.

3. A method according to claim 2 wherein adjusting the low frequency clock comprises,
reducing a frequency of the low frequency clock when the actual time of reception is after the predicted time of reception, and
increasing a frequency of the low frequency clock when the actual time of reception is before the predicted time of reception.

4. A method according to claim 1 wherein determining the new wake-up time for the receiver comprises synchronizing the low frequency clock with a clock of the remote device based on the actual time of reception of the packet and wherein the new wake-up time for the receiver is determined using the synchronized low frequency clock.

5. A method according to claim 1 wherein determining the new wake-up time for the receiver comprises recalculating a frequency of the low frequency clock and/or calculating an offset for the low frequency clock based on the actual time of reception of the packet.

6. A method according to claim 1 wherein detecting the actual time of reception of the packet comprises,
generating samples of a signal received at the receiver using a high frequency clock wherein a frequency of the high frequency clock is significantly greater than a frequency of the low frequency clock, and
detecting a match between an access code of the packet and the samples of the signal received at the receiver.

7. A method according to claim 6 wherein the access code comprises a pseudo-random access code.

8. A method according to claim 7 wherein the pseudo-random access code comprises a Bluetooth pseudo-random access code, and wherein the frequency of the high frequency clock is at least about 10 time greater than the frequency of the low frequency clock.

9. A method according to claim 6 further comprising:
after detecting the match between the access code and the samples, receiving a payload of the packet transmitted from the remote device over the wireless interface.

10. A method according to claim 1 wherein the packet comprises a media data packet, the method further comprising:
receiving a payload of the media data packet;
generating a media data stream including data from the payload; and
decoding the media data stream using the using the low frequency clock and the actual time of reception of the packet.

11. A wireless communications device comprising:
a low frequency clock;
a receiver configured to receive wireless communications from a remote device over a wireless interface; and
a processor coupled to the low frequency clock and coupled to the receiver, wherein the processor is configured to determine a wake-up time for the receiver using the low frequency clock, to use the receiver to listen for reception of a packet transmitted from a remote device over the wireless interface beginning at the wake-up time for the receiver, to detect an actual time of reception of the packet transmitted from the remote device, and to determine a new wake-up time for the receiver using the low frequency clock and the actual time of reception of the packet.

12. A wireless communications device according to claim 11 wherein the processor is further configured to determine a predicted time of reception of the packet transmitted from the remote device, and to determine the new wake-up time for the receiver by adjusting the low frequency clock based on a difference between the predicted and actual times of reception of the packet, wherein the new wake-up time for the receiver is derived from the adjusted low frequency clock.

13. A wireless communications device according to claim 12 wherein the processor is configured to adjust the low frequency clock by,
reducing a frequency of the low frequency clock when the actual time of reception is after the predicted time of reception, and
increasing a frequency of the low frequency clock when the actual time of reception is before the predicted time of reception.

14. A wireless communications device according to claim 11 wherein the processor is configured to determine the new wake-up time for the receiver by synchronizing the low frequency clock with a clock of the remote device based on the actual time of reception of the packet and wherein the new wake-up time for the receiver is determined using the synchronized low frequency clock.

15. A wireless communications device according to claim 11 wherein the processor is configured to recalculate a frequency of the low frequency clock and/or to calculate an offset for the low frequency clock based on the actual time of reception of the packet, and wherein the processor is configured to determine the new wake-up time for the receiver using the recalculated frequency and/or the offset.

16. A wireless communications device according to claim 11 wherein the processor is configured to detect the actual time of reception of the packet by,
detecting a match between an access code of the packet and samples of a signal received at the receiver.

17. A wireless communications device according to claim 16 wherein the access code comprises a pseudo-random access code.

18. A wireless communications device according to claim 17 wherein the pseudo-random access code comprises a Bluetooth pseudo-random access code.

19. A wireless communications device according to claim 16 wherein the processor and the receiver are further configured to receive a payload of the packet transmitted from the remote device over the wireless interface after detecting the match between the access code and the samples.

20. A wireless communications device according to claim 11 wherein the packet comprises a media data packet, and wherein the processor is further configured to receive a payload of the media data packet, to generate a media data stream including data from the payload, and to decode the media data stream using the low frequency clock and the actual time of reception of the packet.
